(19) United States
(12) Patent Application Publication
(10) Pub. No.: US 2016/0059357 A1
(43) Pub. Date: Mar. 3, 2016

(54) CUT PIECE AND CUTTING METHOD FOR MAKING SAME

(71) Applicant: FIH (HONG KONG) LIMITED, Kowloon (HK)

(72) Inventors: CHIA-WEN TSAO, New Taipei (TW); CHAO-HSUN LIN, New Taipei (TW); CHIN-HSIEN HUANG, New Taipei (TW)

(21) Appl. No.: 14/611,619

(22) Filed: Feb. 2, 2015

(30) Foreign Application Priority Data
Aug. 28, 2014 (CN) 201410428927.5

(51) Int. Cl. B23K 26/38; C23F 1/00

(52) U.S. Cl. CPC B23K 26/38; C23F 1/00

(57) ABSTRACT

A cut piece includes a first surface, and a second surface opposite to the first surface. The first surface has at least two grooves, forming at least one support plate located between each two adjacent grooves. The second surface has a plurality of gaps. Each groove is connected with at least one gap.

### FIELD

The present disclosure generally relates to a cut piece and a cutting method for making the cut piece.

### BACKGROUND

Pieces need to be cut by a laser cutting process to have a special pattern. Thick pieces may be deformed during the laser cutting process.

### BRIEF DESCRIPTION OF THE FIGURES

Implementations of the present technology will now be described, by way of example only, with reference to the attached figures.

FIG. 1 is an isometric view of a cut piece, according to a first exemplary embodiment.

FIG. 2 is an enlarged, isometric view of the circled portion II shown in FIG. 1.

FIG. 3 is a cross-sectional view of a cut piece along line III-III of FIG. 1.

FIG. 4 is an isometric view of a cut piece, according to a second exemplary embodiment.

FIG. 5 is an enlarged, isometric view of a circled portion V shown in FIG. 4.

FIG. 6 is a cross-sectional view of a cut piece along line VI-VI of FIG. 4.

FIG. 7 is similar to FIG. 4, but shown from another angle.

FIG. 8 is an enlarged, isometric view of the circled portion VIII shown in FIG. 7.

FIG. 9 is a flow chart of a method of making a cut piece in accordance with a first embodiment.

FIG. 10 is a flow chart of a method of making a cut piece in accordance with a second embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

In the follow description, the term “comprising” when utilized, means “including, but not necessarily limited to”; it specifically indicates open-ended inclusion or membership in the so-described combination, group, series and the like.

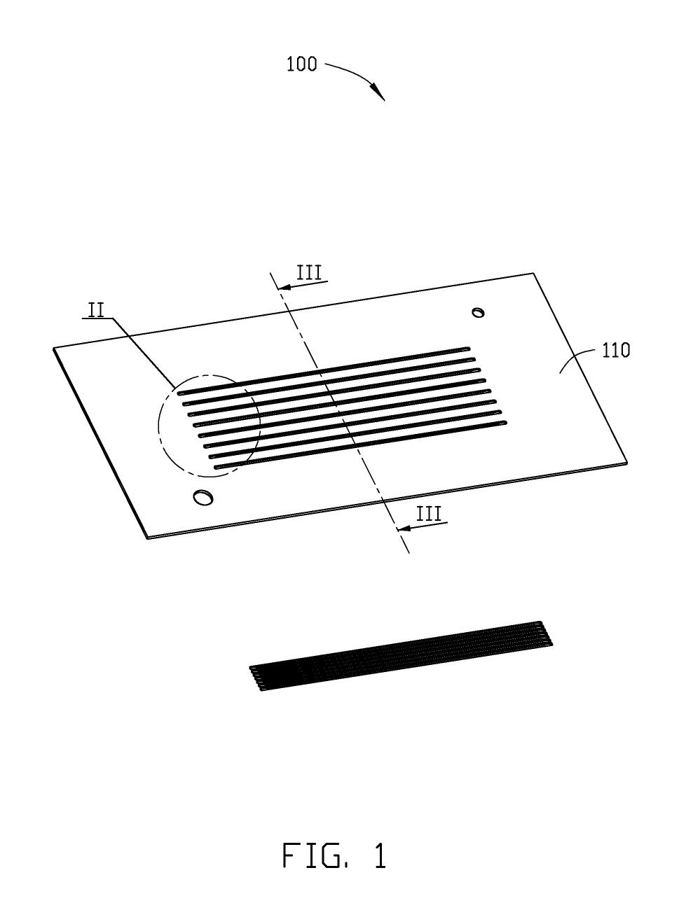

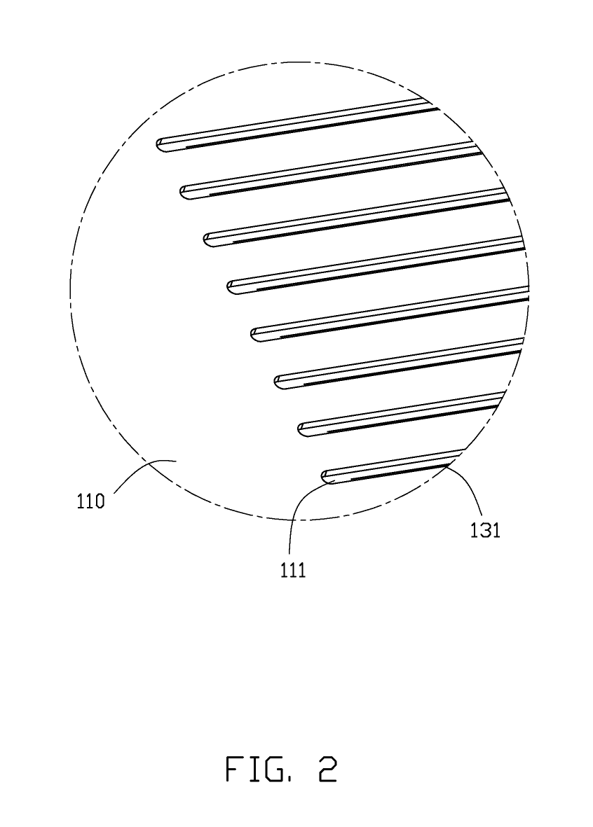

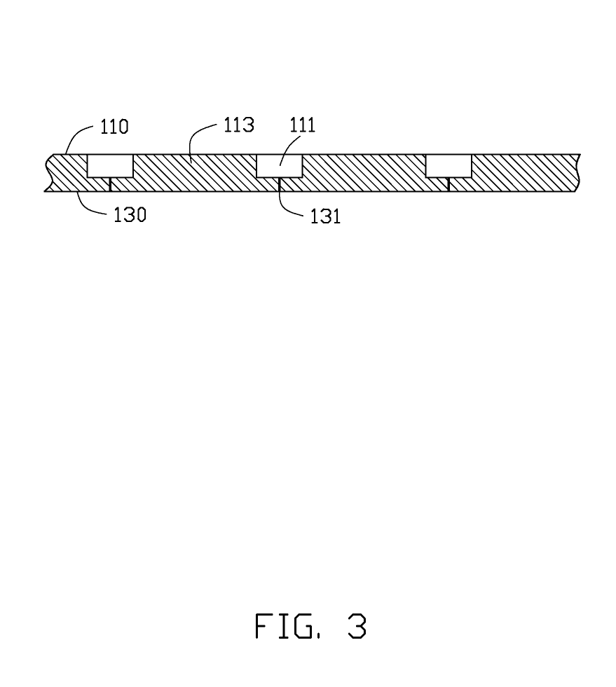

FIGS. 1-3 illustrate a cut piece 100 according to a first exemplary embodiment. The cut piece 100 includes a first surface 110, and a second surface 130 opposite to the first surface 100. The first surface 110 has a plurality of grooves 111 and a plurality of support plates 113 located between each two adjacent grooves 111. The support plate 113 and areas of the first surface 110 free of the grooves 111 lie on the same plane.

Distances between each two adjacent grooves 111 can be the same. In the embodiment, the distance between the each two adjacent grooves 111 is about 0.8 mm. The width of each support plate 113 is about 0.8 mm. The width of each groove 111 can be the same. In at least one embodiment, the width of each groove 111 is about 0.3 mm.

The second surface 130 has a plurality of gaps 131 parallel to the support plates 113. Each gap 131 can be connected with one corresponding groove 111, and located at a middle of the corresponding groove 111. Each gap 131 has a width of about 0.03 mm. The distance between each two adjacent gaps 131 is about 1.2 mm.

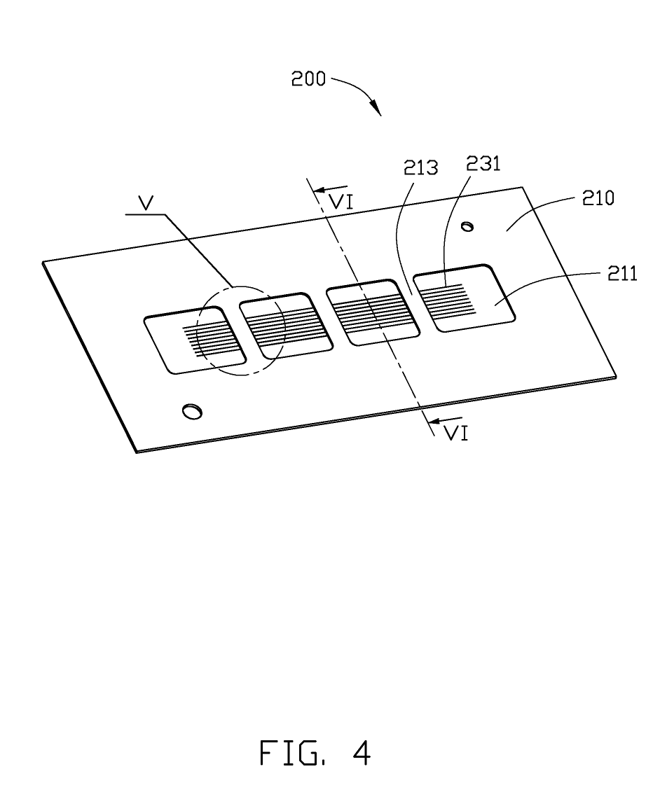

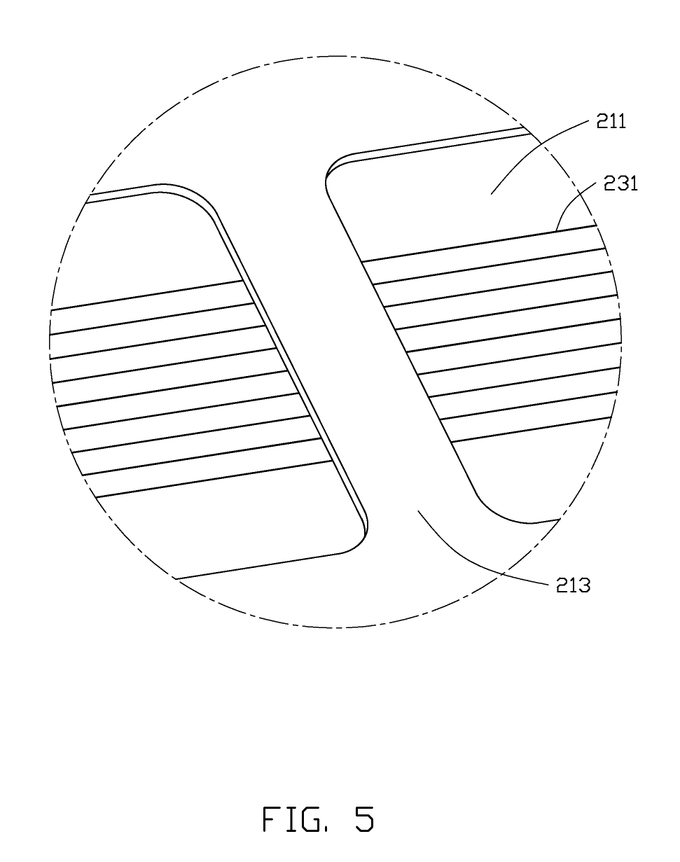

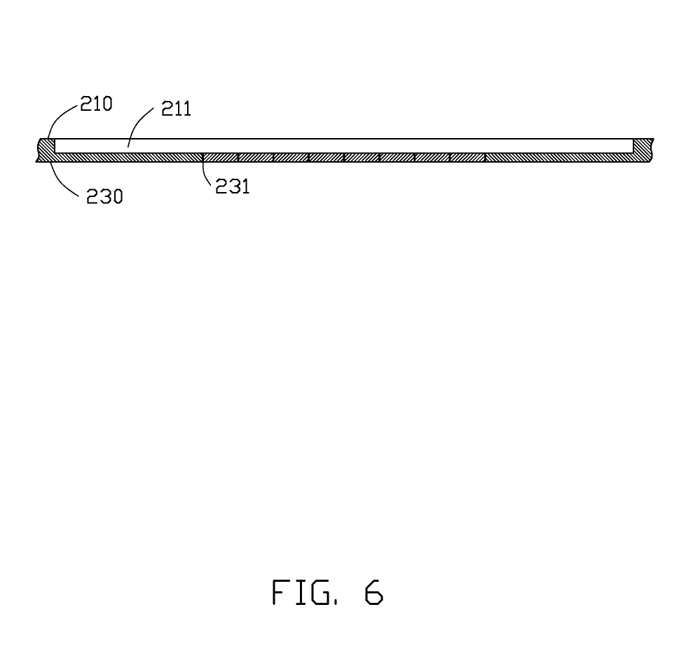

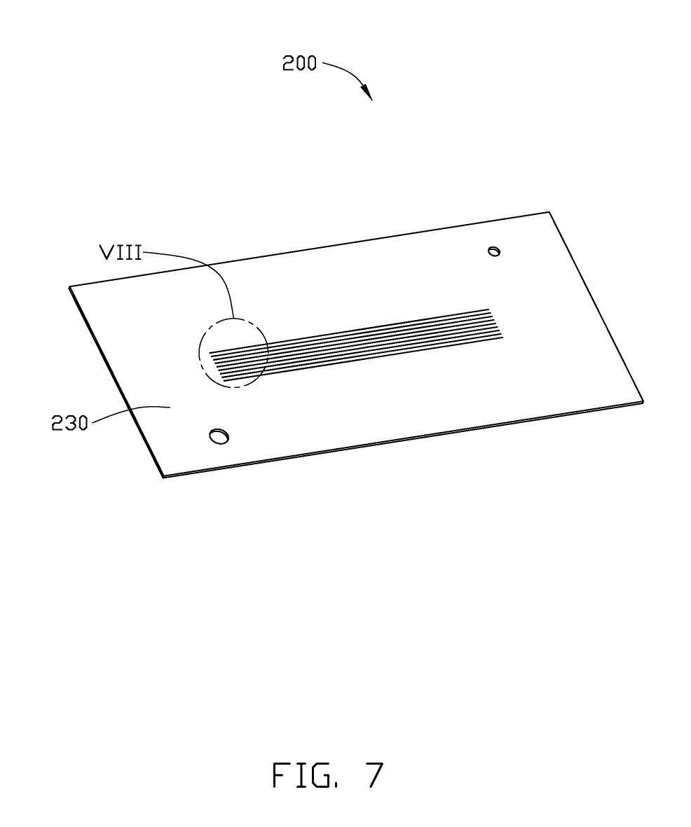

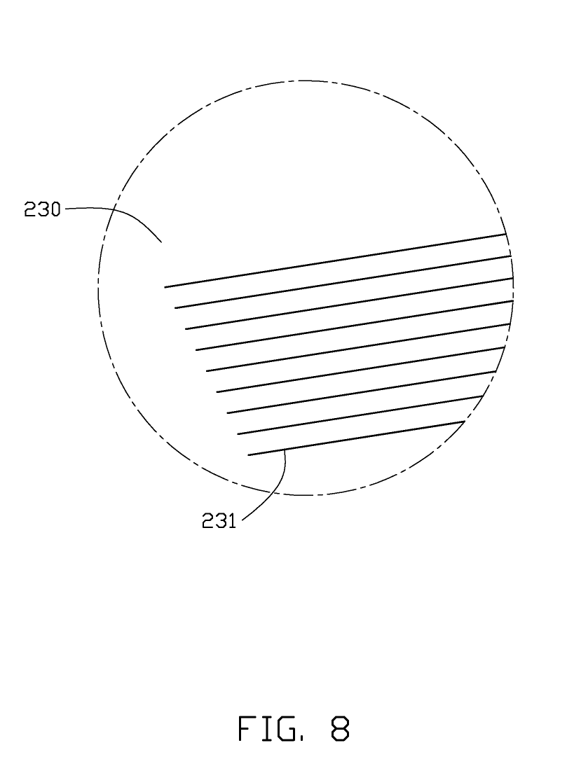

FIGS. 4-8 illustrate a cut piece 200 according to a second exemplary embodiment. The cut piece 200 includes a first surface 210 and a second surface 230 opposite to the first surface 210. The first surface 210 has a plurality of grooves 211 and a plurality of support plates 213 located between each two adjacent grooves 211. Each support plate 213 alternates with one groove 211. The support plate 213 and areas of the first surface 210 free of the grooves 211 lie on the same plane.

The second surface 230 has a plurality of gaps 231 parallel to each other. At least two gaps 231 can be connected with one corresponding groove 211 and located at a middle portion of the corresponding gap 211. Each gap 231 is perpendicular to the support plates 213. Each gap 231 has a width of about 0.03 mm. The distance between each two adjacent gaps 131 is about 1.2 mm.

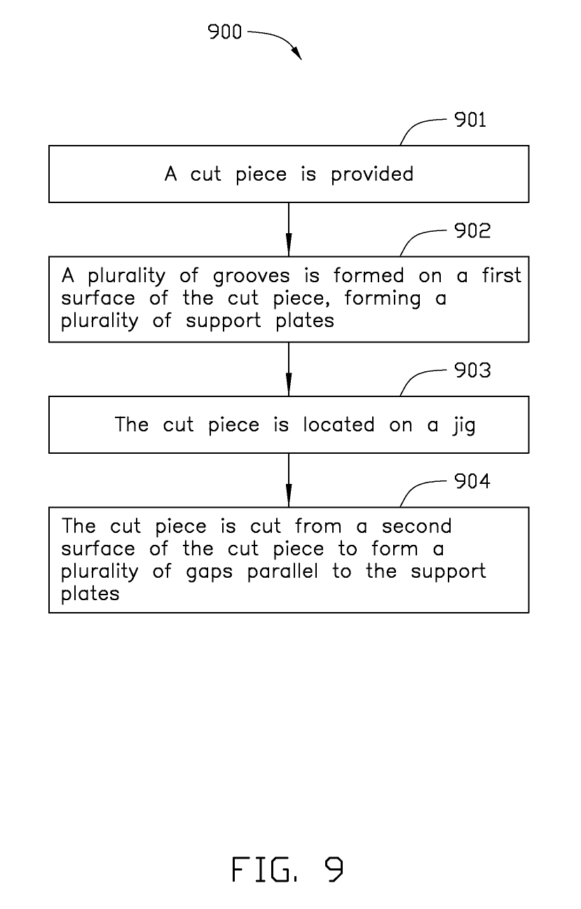

Referring to FIG. 9, a flowchart is presented in accordance with a first example embodiment. The method 900 is provided by way of example, as there are a variety of ways to carry out the method. The method 900 described below can be carried out using the configurations illustrated in FIGS. 1-3, for example, and various elements of these figures are referenced in explaining method 900. Each block shown in FIG. 9 represents one or more processes, methods or subroutines, carried out in the method 900. Furthermore, the illustrated order of blocks is illustrative only and the order of the blocks can change according to the present disclosure. Additional blocks can be added, or fewer blocks can be utilized, without departing from this disclosure. The method 900 can begin at block 901.

At block 901, a cut piece 100 is provided. The cut piece 100 can have any appropriate shape and can be made of any appropriate material. In at least one exemplary embodiment, the cut piece 100 is made of a metal and is substantially sheet-shaped.

The cut piece 100 includes a first surface 110 and a second surface 130 opposite to the first surface 110. In one embodiment, the first surface 110 does not need to be cut, and the cut piece 100 can be cut from the second surface 130.

At block 902, a plurality of grooves 111 are formed on the first surface 110, as such a plurality of support plates 113 is formed on the first surface 110. Each support plate 113 alternates with one corresponding groove 111. In at least one exemplary embodiment, the grooves 111 can be formed by a computer numerical control technology (CNC), or a chemical etching process.

The grooves 111 can have the same size. Each groove 111 has a width of about 0.3 mm. Distances between each two adjacent grooves 111 are the same, and the distances between the each two adjacent grooves 111 is about 0.8 mm. Each support plate 113 has a width of about 0.8 mm.

At block 903, the cut piece 100 is located on a jig (not shown). The support plate 113 and areas of the first surface 110 free of the grooves 111 lie on the same plane. As such the support plate 113 formed on the first surface 110 can cooperate with the jig to fasten the cut piece 100 on the jig.

At block 904, the cut piece 100 is cut from the second surface 130 to define a plurality of gaps 131 by using a laser cutting method. The cut piece 100 is formed to a desired structure. In at least one exemplary embodiment, the gaps 131 are parallel to the support plates 113. Each gap 131 is connected with one corresponding groove 111, and located at a middle of the corresponding groove 111. Each gap 131 has a width of about 0.03 mm. The distance between each two adjacent gaps 131 is about 1.2 mm.

The cut piece 100 can be fastened on the jig via the support plates 113. As such, a location of the cut piece 100 is stationary. Gaps 131 are defined on a bottom of the grooves 111, as portions of the cut piece 100 defining the grooves 111 are thinner than remaining portions of the cut piece 100, as such the cut piece 100 cannot deform during the laser cutting process.

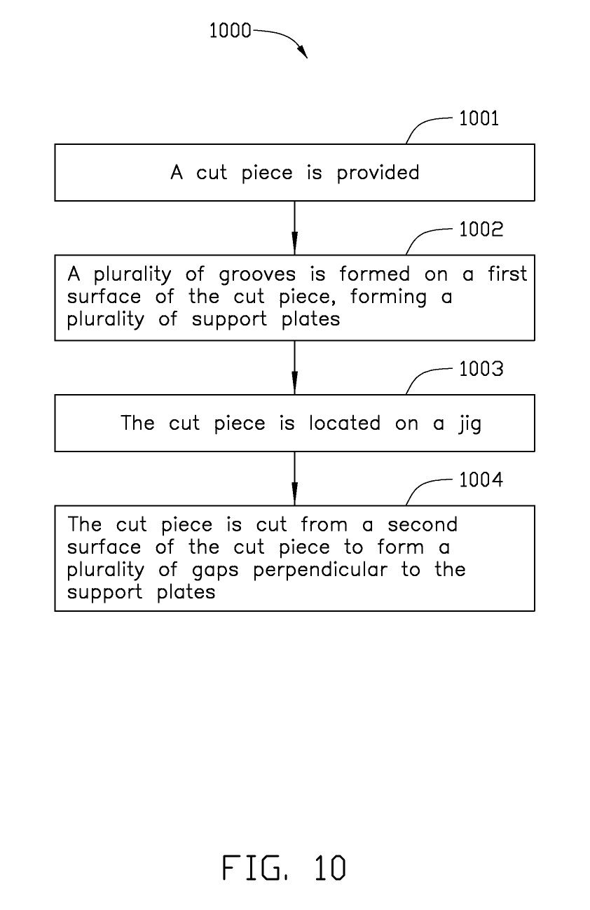

Referring to FIG. 10, a flowchart is presented in accordance with a second example embodiment. The method 1000 is provided by way of example, as there are a variety of ways to carry out the method. The method 1000 described below can be carried out using the configurations illustrated in FIGS. 4-8 for example, and various elements of these figures are referenced in explaining example method 1000. Each block shown in FIG. 10 represents one or more processes, methods or subroutines, carried out in the method 1000. Furthermore, the order of blocks is illustrative only and the order of the blocks can change according to the present disclosure. Additional blocks can be added, or fewer blocks can be utilized, without departing from this disclosure. The method 1000 can begin at block 1001.

At block 1001, a cut piece 200 is provided. The cut piece 200 can be the same as the cut piece 100 as illustrated in the block 901.

The cut piece 200 includes a first surface 210 and a second surface 230 opposite to the first surface 210. In one embodiment, the first surface 210 does not need to be cut, and the cut piece 200 can be cut from the second surface 230.

At block 1002, a plurality of grooves 211 are formed on the first surface 210, as such forming a plurality of support plates 213 parallel to each other. Each support plate 213 alternates with one corresponding groove 211. In at least one exemplary embodiment, the second surface 230 has four rectangular grooves 211 having the same size. In at least one exemplary embodiment, each groove 211 has the same size and the distance between each two adjacent grooves 211 is the same.

At block 1003, the cut piece 200 is located on a jig (not shown). The support plate 213 and areas of the first surface 210 free of the grooves 211 lie in the same plane, such the support plate 213 formed on the first surface 210 can cooperate with the jig to fasten the cut piece 200 on the jig.

At block 1004, the cut piece 200 is cut from the second surface 230 to define a plurality of gaps 231 by a laser cutting method, forming the cut piece 200 to a desired structure. The gaps 231 are parallel to each other. At least two gaps 231 are connected with one corresponding groove 211 and is defined on a bottom of the corresponding groove 211. In at least one exemplary embodiment, the gaps 231 are perpendicular to the support plates 213. Each gap 231 has a width of about 0.03 mm. Distance between each two adjacent gaps 131 is about 1.2 mm.

The cut piece 200 can be fastened on the jig through the support plates 213; as such location of the cut piece 200 is stationary. Gaps 231 are all defined on the bottom of the grooves 211, as portions of the cut piece 200 having the grooves 211 are thinner than remaining portions of the cut piece 200. As such the cut piece 200 cannot deform during the laser cutting method process.

It is to be understood, however, that even through numerous characteristics and advantages of the present disclosure have been set forth in the foregoing description, together with details of assembly and function, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A cut piece comprising:
a first surface defining at least two grooves, and forming at least one support plate located between each two adjacent grooves; and
a second surface opposite to the first surface and having a plurality of gaps, each groove being connected with at least one gap.

2. The cut piece as claimed in claim 1, wherein each groove has the same size, and distances between each two adjacent grooves are the same.

3. The cut piece as claimed in claim 1, wherein the support plate and areas of the first surface free of the grooves lie on the same plane.

4. The cut piece as claimed in claim 1, wherein each support plate alternates with one corresponding groove.

5. The cut piece as claimed in claim 1, wherein the gaps are parallel to the support plate.

6. The cut piece as claimed in claim 5, wherein each groove has a width of about 0.3 mm, a distance between each two adjacent grooves is about 0.8 mm.

7. The cut piece as claimed in claim 5, wherein each gap has a width of about 0.03 mm, a distance between each two adjacent gap is about 1.2 mm.

8. The cut piece as claimed in claim 5, wherein one gap corresponds to a groove, and is formed on a bottom of the corresponding groove.

9. The cut piece as claimed in claim 1, wherein the gaps are perpendicular to the support plate.

10. The cut piece as claimed in claim 9, wherein each gap has a width of about 0.03 mm, distance between each two adjacent gaps is about 1.2 mm.

11. The cut piece as claimed in claim 9, wherein at least two gaps are connected with one corresponding groove, and formed on a bottom of the corresponding groove.

12. A cutting method for making a cut piece comprising:
providing a cut piece, the cut piece having a first surface and a second surface opposite to the first surface;
forming at least two grooves on the first surface, such forming at least one support plate located between each two adjacent grooves; and
forming a plurality of gaps on the second surface, each groove being connected with at least one gap.

13. The cutting method as claimed in claim 12, wherein cutting method further includes a step of locating the cut piece on a jig, the support plate and areas of the first surface free of the grooves lie on the same plane, such the support plate formed on the first surface cooperates with the jig to fasten the cut piece on the jig.

14. The cutting method as claimed in claim 12, wherein each groove has the same size, and distances between each two adjacent grooves are the same.

15. The cutting method as claimed in claim 12, wherein each support plate alternates with one corresponding groove.

16. The cutting method as claimed in claim 12, wherein the gaps are parallel to the support plate, one gap is corresponding to a groove, and formed on a bottom of the corresponding groove.

17. The cutting method as claimed in claim 16, wherein each groove has a width of about 0.3 mm, a distance between each two adjacent grooves is about 0.8 mm.

18. The cutting method as claimed in claim 16, wherein each gap has a width of about 0.03 mm, a distance between each two adjacent gap is about 1.2 mm.

19. The cutting method as claimed in claim 12, wherein the gaps are perpendicular to the support plate, at least two gaps are connected with one corresponding groove, and formed on a bottom of the corresponding groove.

20. The cutting method as claimed in claim 19, wherein each gap has a width of about 0.03 mm, distance between each two adjacent gaps is about 1.2 mm.
